(19) United States
(12) Patent Application Publication
(10) Pub. No.: US 2006/0107631 A1
(43) Pub. Date: May 25, 2006

(54) Dust-bag previously pressing hook for a dust collecting machine

(75) Inventor: Yuan-Tai Cheng, Taichung (TW)

Correspondence Address: TROXELL LAW OFFICE PLLC, SUITE 1404, 5205 LEESBURG PIKE, FALLS CHURCH, VA, 22041, US

(73) Assignee: San Ford Machinery Co., Ltd.

(21) Appl. No.: 10/995,379

(22) Filed: Nov. 24, 2004

(51) Int. Cl. B01D 46/02

(52) U.S. Cl. 55/378

(57) ABSTRACT

A dust-bag previously pressing hook for a dust collecting machine is made of an elongate metal wire, wounded to have a combining portion in an upper portion, a coil portion in an intermediate portion and a straight portion in a lower portion. The combining portion is adjustably tightened or loosened on an annular ring of a wind exhaust tank, and the straight portion has an end hook to press against the annular wall by means of the torque coming from the coil portion. Then the end hook can previously press a dust bag moved up around the annular ring to let its mouth reach the end hook to be previously pressed by the end hook before the dust bag is secured tightly to be kept steady without falling down during subsequent dust collecting work.

### BACKGROUND OF THE INVENTION

1. Field of the Invention

This invention relates to a dust collect machine, particularly to one provided with a dust-bag previously pressing hook for previously pressing a dust bag against around an annular wall of a wind exhausting tank so as to subsequently secure stably the dust bag with the wind exhausting tank.

2. Description of the Prior Art

Medium and large dust collect machines generally have a wind exhausting tank, and one or more annular rings for a mouth of a dust bag to be fitted and secured stably around with an annular constrictor. However, the duct bag is sub substantially heavy, so in fitting and securing its mouth around the annular member may be quite hard to perform by only one person if it is not previously held. Dust bag positioning device for a dust collecting machine as shown in FIG. 1 includes plural positioning members 10 made of a metal plate bent, and they are fixed on annular wall of the annular rings. Each positioning members 10 has a connecting portion 11 formed upright in an upper portion, an L-shaped intermediate portion 12 continuing downward from the connecting portion 11, and a hooking portion 13 bending from the lower end of the L-shaped intermediate portion and having a bent-up triangular hook for hooking a dust bag that is fitted around the annular ring of the wind exhausting tank.

However, the hooking portion 13 of the positioning member 10 has a proper elasticity by means of the L-shaped portion 12 and pushed against the wall surface of the annular member, but its elasticity is not so good, liable to produce fatigue and becoming impossible to effectively and previously hook a dust bag so that the dust bag cannot be kept stably in its position during subsequent dust collecting work. Besides, the positioning member is made of a metal plate by bending process to make its lower end formed as the hook portion with a pointed cone shape for hooking. But this shape is not convenient for producing. In addition, the connecting portion 11 is tightly connected with the annular member, impossible to be adjusted in its position for receiving balanced force, if the positioning members 10 are not positioned all right. Then a dust bag may be inclined, needing repositioning, resulting in unnecessary waste of work.

### SUMMARY OF THE INVENTION

A dust-bag previously pressing hook for a dust collecting machine is made of an elongate metal wire, wound to form a combining portion in an upper portion, a coil portion in an intermediate portion and a straight portion in a lower portion. The combining portion is adjustably secured on an annular ring of a wind exhaust tank, and the straight portion has an end hook to press against the annular ring by means of the torque gotten from the coil portion. So a dust bag is moved up around the annular rind to let its mouth reach the end hook and to be pressed previously stably against the annular ring before the dust bag is secured tightly with the annular ring and kept at that secured position without falling down during subsequent dust collecting work.

### BRIEF DESCRIPTION OF DRAWINGS

This invention will be better understood by referring to the accompanying drawings, wherein:

FIG. 1 is a perspective view of a conventional positioning member for a dust bag for a dust collecting machine;

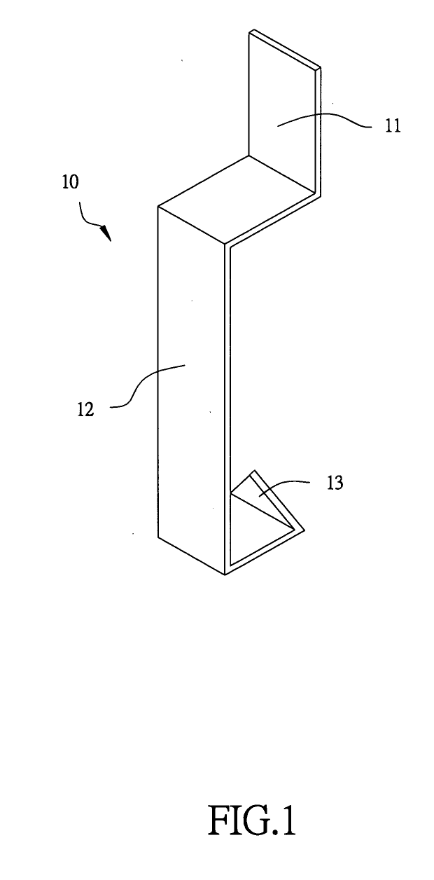

FIG. 2 is a front view of a dust collecting machine with a dust bag previously pressing hook in the present invention;

FIG. 3 is a perspective view of a dust bag previously pressing hook fixed on an outer surface of an annular ring of a wind exhaust tank in the present invention;

FIG. 4 is an exploded perspective view of the dust bag previously pressing hook in the present invention;

FIG. 5 is a side view of the dust bag previously pressing hook installed in its position in the present invention;

FIG. 6 is a side view of a dust bag fitted around the annular ring and pressed stably by the dust-bag previously hanging hook in the present invention; and,

FIG. 7 is a side view of the dust-bag previously hanging hook pulled off the dust bag fitted around the annular ring in the present invention.

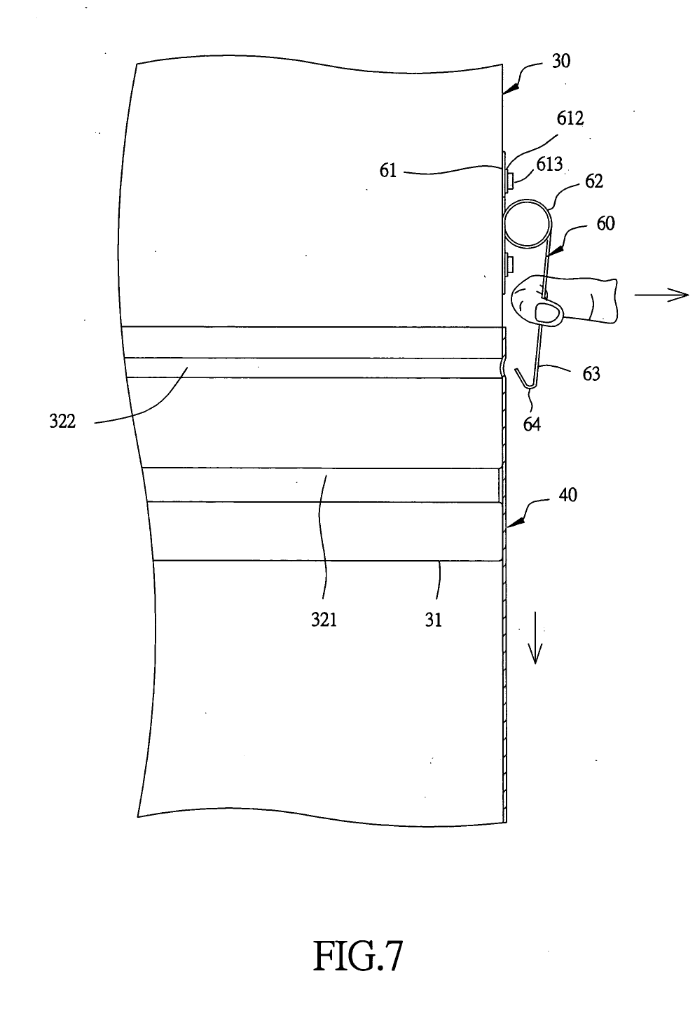

### DETAILED DESCRIPTION OF THE PREFERRED EMBODIMENT

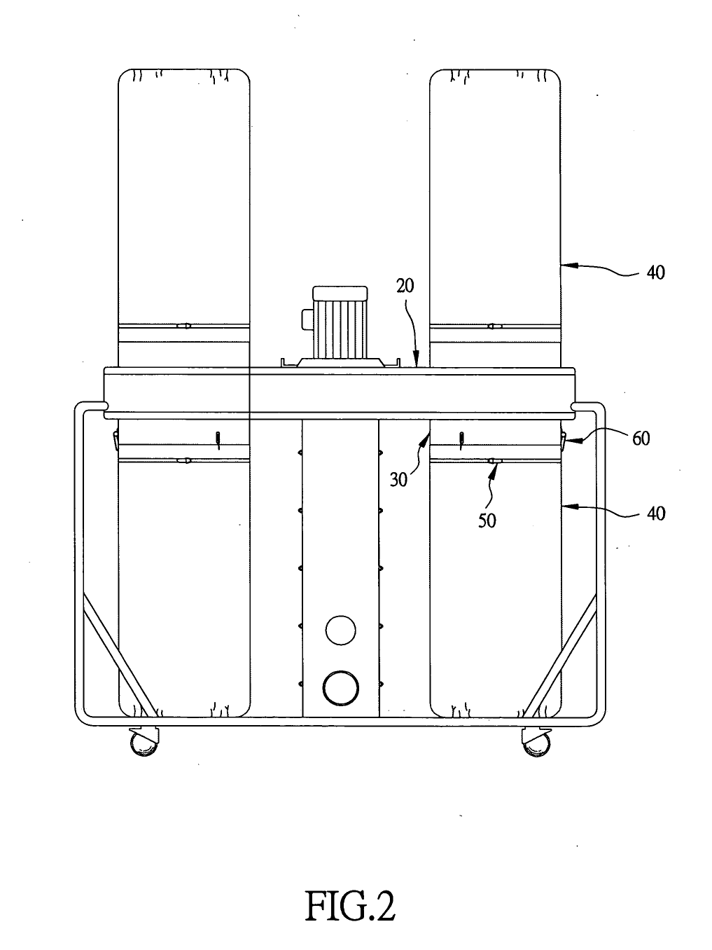

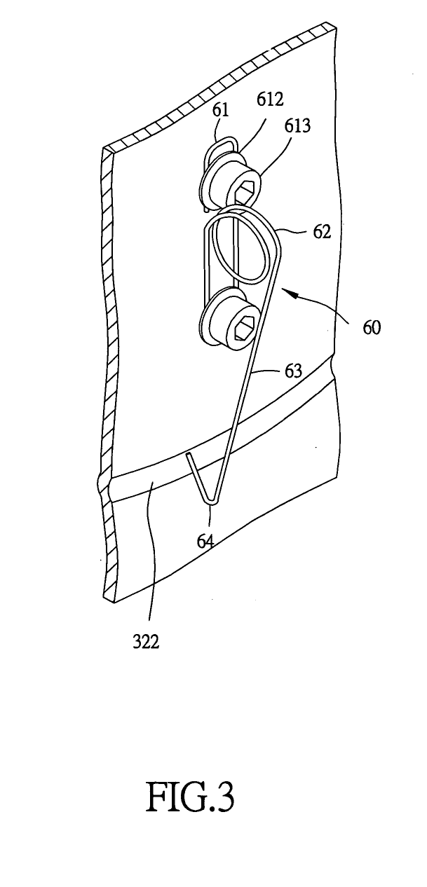

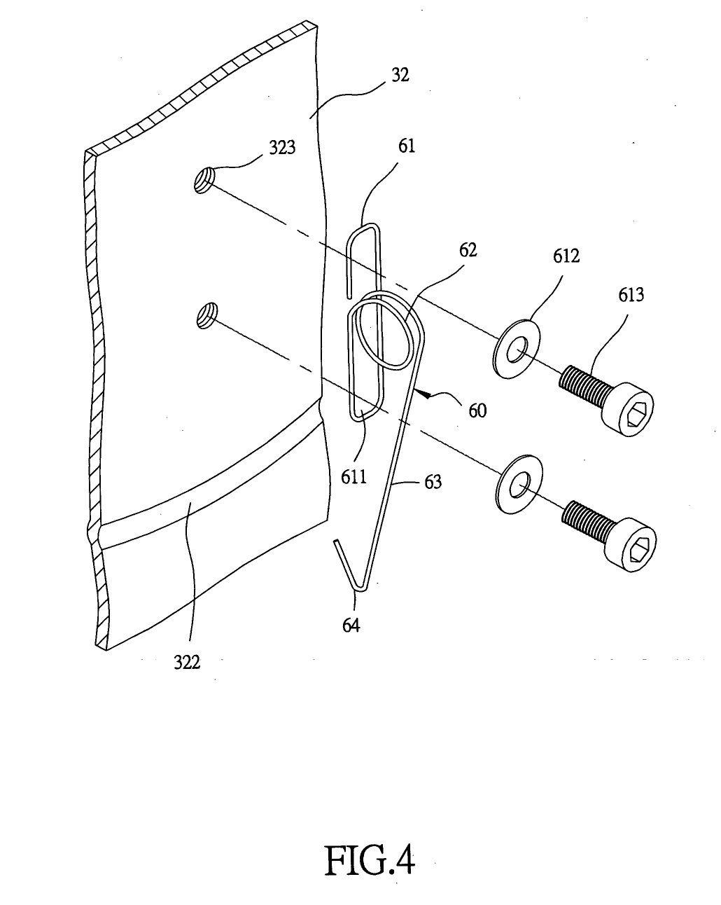

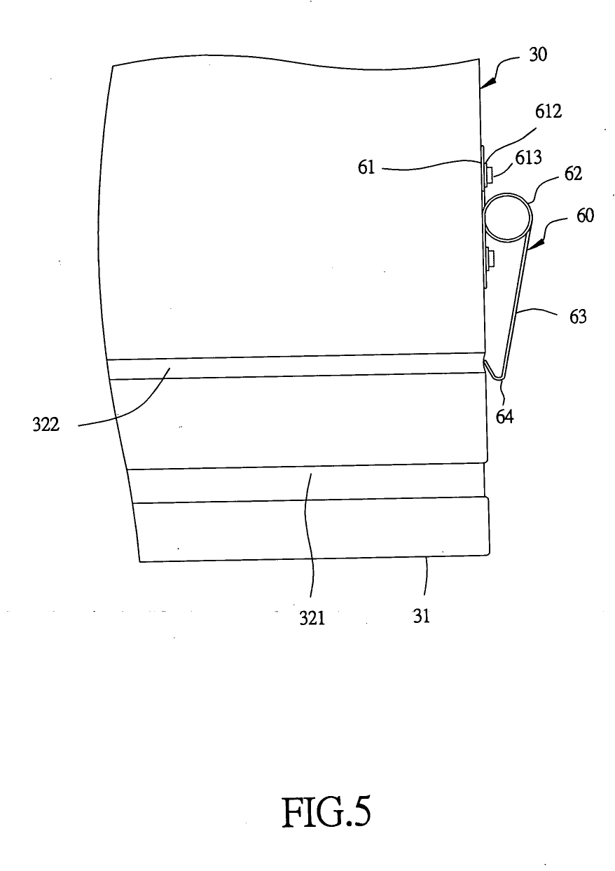

A preferred embodiment of a dust-bag previously pressing hook for a dust collecting machine in the present invention, as shown in FIGS. 2, 3, 4 and 5, includes a dust-bag previously pressing hook 60 to be fixed on several locations on an annular ring 30 of a wind exhaust tank 20 and an annular constrict 60.

When a dust bag 40 has its mouth 41 fitted and secured around the outer surface 32 of the annular ring 30, the annular constrictor 50 is used to constrict the annular groove 321 and the dust bag 40 stably and tightly. And the dust bag 40 is to be pressed previously by the dust-bag pressing hook 60 before the annular constrictor 50 constricts the dust bag 40 at its position.

Each annular ring 30 has the outer surface 32, an annular groove 321 near a wind exhaust hole 31, an annular shallow groove 322, and plural threaded holes 323 in the outer surface 32 near the annular shallow groove 322.

The dust-bag previously pressing hook 60 is made of an elongate metal wire wound to form a combining portion 61 with its two U-shaped ends 611 fixed tightly or loosened on the screw holes 613 of the outer surface 32 with a washer 612, an intermediate coil portion 62 continuing from the combining portion 61, and a lower straight portion 63 with an end hook 64 continuing from the intermediate coil portion 62. Then the end hook 64 can elastically press against the annular shallow groove 322 by means of the torque of the coil portion 62.

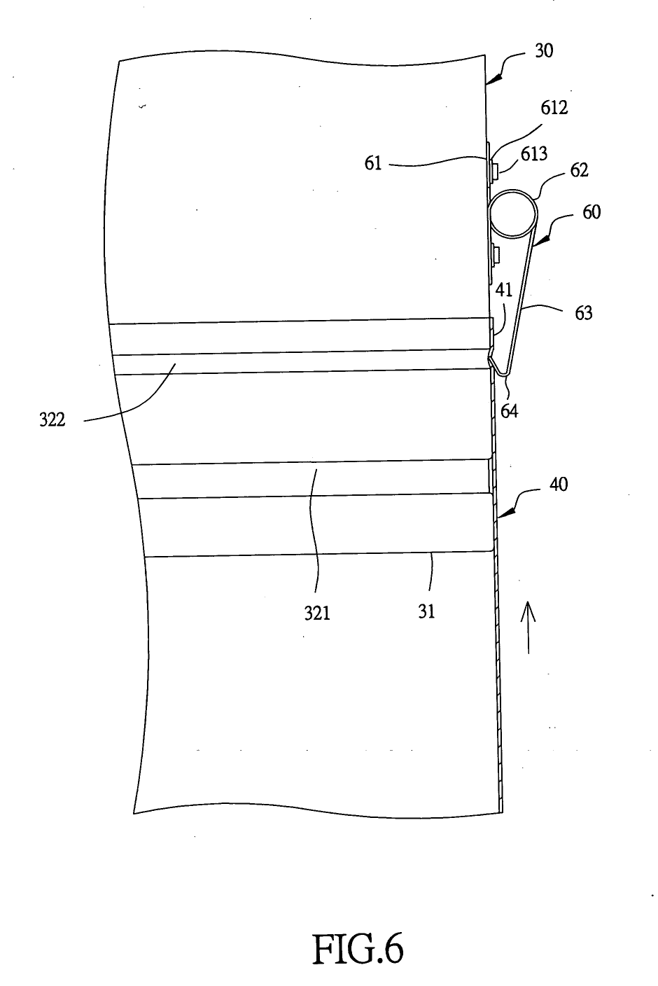

In using, referring to FIG. 6, the mouth 41 of a dust bag 40 is handled to move up around the outer surface 32 of the annular ring until the mouth 41 passes under the end hook 64 being pulled off the annular shallow groove 322. Then a worker releases the dust bag 40 with its mouth 41 covering the shallow groove 322 after the end hook 64 is released to press against the dust bag 40 and also the shallow groove 322 so that the dust bag 40 can be secured stably and not fall down. Then the annular constrictor 50 is used to constrict the dust bag 41 around the annular wall 32 tightly and securely, as shown in FIG. 2.

On the contrary, if the dust bag 40 fixed on the annular ring 30 is to be taken off, a worker pulls the end hook 60 off the dust bag 40 and the annular shallow groove 322 of the annular wall 32, with the straight portion 63 pulled back to permit the end hook 64 separating from the dust bag 40 and also the annular shallow groove 322, and then the annular constrictor is removed off to let the dust bag 40 free to be pulled off the annular wall 32.

As can be understood from the foresaid description, the invention has the following advantages.
1. The dust-bag preciously pressing hook 60 receives comparatively good torque from the coil portion 62 with an fatigue-enduring property, so the end hook 64 connected to the straight portion 63 can previously press a dust bag 40 stably with considerable force so as to let the annular constrictor 50 constrict the dust bag tightly without falling down during subsequent work for collecting dust therein. And the hook 60 may have a long service life.
2. The combining portion 61 of the dust-bag previously pressing. hook 60 can have its location shifted by tightening and loosening the adjust screws 613 so the plural previously pressing hooks 60 may have balanced force to keep the dust bag 40 balanced in a level condition, not to incline to any direction.
3. When the end hook 64 presses the mouth 41 of a dust bag 40 against the shallow groove 322, the mouth 41 may be inclined a bit so the pressing function of the end hook 64 may be comparatively good.

While the preferred embodiment of the invention has been described above, it will be recognized and understood that various modifications may be made therein and the appended claims are intended to cover all such modifications that may fall within the spirit and scope of the invention.

What is claimed is:

1. A dust-bag previously pressing hook for a dust colleting machine, said previously pressing hook fixed adjustably on an annular ring fixed near a wind exhaust hole of a wind exhaust tank for pressing previously the dust bag before it is secured tightly, said dust-bag previously pressing hook made of an elongate metal wire and having characteristics of:
A combining portion formed in an upper portion to be combined adjustably with said annular ring, said combining portion continuing to a coil portion formed in an intermediate portion of said pressing hook, said coil portion continuing to a straight portion of said pressing hook for pulling, said straight portion having an end hook bent to point to said annular ring, said end hook keeping on pressing against said annular ring by means of torque coming from said coil portion so that a mouth of a dust bag may be previously pressed stably by said end hook on said annular ring when the mouth of the dust bag is moved up around said annular ring to reach the end hook before the dust bag is secured tightly around said annular ring.

2. The dust-bag previously pressing hook for a dust collecting machine as claimed in claim 1, wherein said combining portion of said dust-bag previously pressing hook is provided with a U-shaped member respectively in its two end sections, and said U-shaped portions are adjustably tightened or loosened on said annular ring by adjusting screws so that said combining portion can be adjusted in its location in some extent.

3. The dust-bag pressing hook for a dust collecting machine as claimed in claim 1, wherein said annular ring has an annular shallow groove for said end hook of said dust-bag previously pressing hook to press elastically against.
